(19) United States
(12) Patent Application Publication
(10) Pub. No.: US 2026/0208538 A1
(43) Pub. Date: Jul. 23, 2026

(54) WINTER CAR TYRE

(71) Applicant: Pirelli Tyre S.p.A., Milano (IT)

(72) Inventors: Giovanni CASAROTTO, Milano (IT); Stefano MONTESELLO, Milano (IT); Diego SPEZIARI, Milano (IT)

(73) Assignee: Pirelli Tyre S.p.A., Milano (IT)

(21) Appl. No.: 19/137,635

(22) PCT Filed: Dec. 15, 2023
(86) PCT No.: PCT/IB2023/062764

§ 371 Date: Jun. 10, 2025

(30) Foreign Application Priority Data
Dec. 22, 2022 (IT) 102022000026484
Feb. 21, 2023 (EP) 23157755.2
Jul. 20, 2023 (EP) 23186708.6

(51) Int. Cl. B60C 11/03; B60C 11/12

(52) U.S. Cl. CPC B60C 11/0302; B60C 11/033; B60C 11/12; B60C 2011/0344; B60C 2011/0372

(57) ABSTRACT

A winter car tyre (100) is described, in particular a winter car tyre able to deliver high driving torque and/or to reach high speeds, provided with a tread band comprising transverse sipes (13), wide and deep pairs of first transverse grooves (2, 3) which are widely extended and alternate with pairs of second transverse grooves (4, 5) which are of non-negligible extent but are smaller wide and deep and are counter-inclined relative to the first transverse grooves (2, 3).

### FIELD OF THE INVENTION

This invention relates to a winter car tyre. Specifically, the present invention relates to a winter car tyre able to deliver high driving torque and/or to reach high speeds.

### Known Art

The following documents describe some examples of winter tyres: EP 485883, U.S. Pat. No. 5,435,366, WO 02/068221, WO 02/68222, WO 2004/056588, WO 2008/074353, WO 2019/030664.

### SUMMARY OF THE INVENTION

Winter tyres are generally required to have good traction and braking qualities when used on snowy and/or icy surfaces, as well as good braking characteristics when used on wet roads. Furthermore, winter tyres are required to have good driving performance on dry roads and low noise levels.

Winter or snow tyres are therefore generally designed with a tread band provided with tread blocks spaced by wide and deep longitudinal and/or transverse grooves which allow good traction, snow braking qualities and water drainage from the contact patch.

The void-to-rubber ratio of the tread band, that is the amount of open space relative to the amount of rubber in the tread, is increased thanks to the wide and deep grooves. A high void-to-rubber ratio denotes less rubber in contact with the road, and vice versa.

However, wide grooves reduce the stiffness of the tread band and can generate excessive noise.

Winter tyres designed for cars capable of delivering high driving torque and/or reaching high speeds, such as sports cars, are also required to have traction/braking performance, roadholding, and trajectory accuracy, particularly on dry road surfaces at high speeds.

For this purpose the tread bands, including those of winter tyres, should be provided with a tread pattern characterised by a low void-to-rubber ratio.

In view of the above, it is clear that a winter tyre and in particular a winter tyre intended for passenger cars capable of delivering high driving torque and/or reaching high speeds must meet several conflicting requirements in order to provide good performance in various road and weather conditions.

For example, the Applicant manufactured winter tyres with asymmetric tread patterns, i.e. tyres whose tread is formed by two regions, an inner one and an outer one, respectively, which are defined by the equatorial plane and differ from each other substantially in the presence, distribution and shape of grooves and/or tread blocks.

Each of the two regions tends to be configured to respond to different stresses and demands the tyre is subjected to when driving on various road surfaces (dry, wet and snowy).

In particular, the inner part can be designed to respond better when used on snowy or wet terrain, i.e. it can be distinguished by greater presence of grooves and/or sipes, whereas the outer part can be designed to perform better when traveling on dry terrain, i.e. it can be characterized by a lower void-to-rubber ratio.

However, the Applicant noted that winter tyres provided with asymmetric tread can exhibit average stiffness due to the specificity of design and to the behavior of each region of the tread band in the footprint area.

Such a characteristic can lead to reduction in performance, increased noise, uneven wear and reduction in the total distance traveled by the tyres.

In order to improve the performance of winter car tyres and in particular winter tyres for high-powered sports cars, the Applicant developed a tyre provided with a tread band with directional pattern, made with pairs of first and second transverse grooves and with transverse sipes. The arrangement of the pairs of grooves and sipes allowed a moderate variation in the average stiffness of the tread band in the footprint area, resulting in high traveling performance in different weather conditions.

In a first aspect, the invention relates to a tyre provided with a tread band having an effective width and comprising a plurality of grooves distributed so as to set a void-to-rubber ratio equal to or greater than 0.3 in said tread band.

The plurality of grooves preferably comprises:
a central circumferential groove, located at an equatorial plane of said tyre so as to separate a first region and a second region of the tread band from each other; and/or
a plurality of pairs of first transverse grooves; each pair having two first transverse grooves opposed to each other relative to said equatorial plane.

Preferably, each of said first two transverse grooves has a first end located substantially at a respective edge of either said first region or said second region of the tread band.

Preferably, each of said first two transverse grooves has a maximum width greater than or equal to 4 mm, and/or an extent equal to at least 40% of the effective width of said tread band.

In addition, the plurality of grooves preferably comprises a plurality of pairs of second transverse grooves, each pair having two second transverse grooves opposed to each other relative to said equatorial plane, counter-inclined relative to said first transverse grooves, and intersecting the first transverse grooves in said first region or in said second region of said tread band, respectively.

Preferably, the second transverse grooves have a maximum width and a depth smaller than or equal to those of said first transverse grooves, and/or an extent equal to at least 35% of the effective width of the tread band.

Preferably, said tread band further comprises a plurality of first transverse sipes extending concordantly to said first transverse grooves.

The Applicant manufactured a tyre with an unrestricted void-to-rubber ratio defined by pairs of first and second grooves as well as widely extended and inclined transverse sipes so as to ensure drainage, traction and braking qualities particularly on snowy and/or icy surfaces.

Without wishing to adhere to any particular theory, the Applicant believes that the difficulty in achieving high levels of performance in winter car tyres and in particular in winter tyres for high-powered sports cars is essentially related to the difficulty in maintaining a determined average stiffness of the tread band and in particular in the axial direction.

In general, the Applicant believes that providing a tread band with pairs of grooves, which are opposed relative to the equatorial plane and counter-inclined, can define portions of regular and uniform tread band particularly in the axial direction, so as to reduce the mobility of such portions and thus increase their compactness to the benefit of performance.

In addition, the transverse sipes have such a distribution and extent that the number of intersections with the remaining transverse grooves is minimized or reduced to zero in order to avoid any localized weakening of the tyre stiffness, which thus remains essentially constant over the entire footprint area, particularly in the axial direction.

For the purposes of this invention, the following definitions apply:

“Tread pattern” means the representation of all the points of the tread band (including channels) on a plane perpendicular to the equatorial plane of the tyre and tangent to the maximum diameter of the tyre.

“Symmetrical tread pattern” means a tyre whose tread is formed by two regions, a first one and a second one, respectively, which are defined by the equatorial plane and are substantially symmetrical except for limited circumferential offsets due, for example, to the need for reducing tyre rolling noise.

A tyre whose tread pattern is specially designed to rotate in a preferred driving direction is called a “directional” tyre.

Measures of angles and/or linear quantities (distances, widths, lengths, etc.) and/or surfaces are intended to be referred to the tread pattern as defined above.

“Axial design” of the tread band or portions thereof means the design of the radially outermost profile of the tread band or portions thereof in a tyre cross-section made in a plane containing the axis of rotation of the tyre.

In addition, referring to the angle or inclination of the channels formed in the tread band, it is to be understood in relation to the equatorial plane of the tyre (or to a direction parallel thereto) and, more precisely, it is to be understood for each point of the channel as referring to the angle (from 0° to 90° in absolute value) formed by a rotation performed starting from the equatorial plane to the direction tangent to the channel passing through that point.

“Equatorial plane” of the tyre means a plane perpendicular to the axis of rotation of the tyre and partitioning the tyre into two equal parts.

“Circumferential” direction means a direction generally oriented in the direction of tyre rotation, or anyway slightly inclined (e.g., at most about) 10° from the direction of tyre rotation.

“Axial” direction means a direction that is substantially parallel to the axis of rotation of the tyre or, at most, slightly inclined (e.g., at most about) 15° from that axis of rotation of the tyre. Generally, the axial direction is substantially perpendicular to the circumferential direction.

“Void-to-rubber ratio” means the ratio of the total surface of the channels of a given annular region of the tread band (possibly of the whole tread band) to the total surface of said given annular region (possibly of the whole tread band).

“Effective width” of the tread band is defined as the width of the radially outermost portion of the tread band, that is, the portion of the tread band intended to contact the ground. Typically, this effective width can be defined on a tyre cross-section, and/or on its tread band, as the distance between the axially outermost points of the radially outermost portion of the tread band. If applicable, these points can be defined by the intersection of extensions in a substantially axial direction of the radially outermost portion of the tread band and extensions in a substantially radial direction of the axially outermost portions of the tread band, in case the tread band does not have well-defined edges and/or has rounded edges.

The term “groove” means a channel made in a portion of the tread band and having width of 1.5 mm or more, and preferably depth of 2 mm or more.

The term “sipe” means a channel made in a portion of the tread band and having width smaller than 1.5 mm, preferably smaller than or equal to 1 mm.

Two groove segments or sections or two grooves are disjoined if they are separated at least at their respective mutually facing ends.

Two groove segments or sections or two grooves are substantially skew when their longitudinal axes, at least at their respective mutually facing ends, are offset by a value greater than their width (considering the greater width in the case of segments, sections or grooves of different widths). Otherwise, two segments, sections or grooves are defined “substantially aligned”. The misalignment value is measured as the distance between the respective longitudinal axes.

The present invention, in one or more preferred aspects, can comprise one or more of the following features.

Preferably, the first grooves can have a second end located substantially at the equatorial plane.

Conveniently, the first grooves can have an inclination which increases moving away from the equatorial plane.

Advantageously, at the second end, the first grooves can have an inclination forming an angle equal to or smaller than 60° and preferably greater than or equal to 40° relative to a direction parallel to the equatorial plane.

Conveniently, at the first end, the first grooves can have an inclination forming an angle greater than or equal to 75° relative to a direction parallel to the equatorial plane.

Preferably, at least some of the first transverse grooves can terminate into the central circumferential groove at the respective second end.

This way, they are in fluid communication with the circumferential groove thus allowing the water in the footprint area to be rapidly channeled away, when driving on a wet surface.

Conveniently, some of the first transverse grooves have second ends spaced away from the central circumferential groove.

Advantageously, the first transverse grooves of a pair of first transverse grooves have no points of intersection with the first transverse grooves of the circumferentially consecutive pair of first transverse grooves.

Preferably, the second transverse grooves of a pair of second transverse grooves have no points of intersection with the second transverse grooves of the circumferentially consecutive pair of second transverse grooves.

Conveniently, some second transverse grooves can extend from the second ends of the first transverse grooves.

Conveniently, the second transverse grooves comprise at least one substantially straight first section and at least one substantially straight second section arranged consecutively to the first section; the second section can have an extent greater than the extent of the first section.

Preferably, the second section can have an inclination smaller than the first section.

Advantageously, the first section can have an inclination forming an angle equal to or smaller than 75° and greater than or equal to 40° relative to a direction parallel to the equatorial plane.

Advantageously, the second section can have an inclination forming an angle equal to or smaller than 50° and greater than or equal to 20° relative to a direction parallel to the equatorial plane.

Advantageously, the first section comprises at least two disjoined segments. The aforesaid disjointed segments can be skew. Preferably, the disjoined segments of the first section can be provided to be skew by a maximum distance of five times the width of the same segments.

Conveniently, the second section can comprise at least three disjoined segments.

Advantageously, the second section can comprise five disjoined segments. Preferably, the aforesaid disjoined segments can be skew. Preferably, the disjoined segments of the second section can be provided to be skew by a maximum distance of five times the width of the same segments.

Preferably, the second section can intersect at least two first transverse grooves, preferably at least three first transverse grooves.

Preferably, the intersections of the first transverse grooves with the second sections of the second transverse grooves can form substantially right angles.

Conveniently, the first section of the second transverse grooves intersects at least one first transverse groove.

Preferably, the intersections of the first transverse grooves with the first section of second transverse grooves form acute angles smaller than or equal to 75°.

Conveniently, the plurality of grooves can comprise pairs of substantially straight third transverse grooves opposed to each other relative to the equatorial plane.

Advantageously, the third transverse grooves are arranged in two circumferential rows of third transverse grooves opposed to each other relative to an equatorial plane of the tyre.

Preferably, some of the third grooves can extend from an end of the second section of the second transverse grooves.

Advantageously, the third transverse grooves can extend toward the respective edge of the tread band, so as to form an angle equal to or greater than 75° relative to a direction parallel to the equatorial plane.

Conveniently, the third transverse grooves can have width smaller than or equal to the width of the first transverse grooves.

Advantageously, the third transverse grooves of a pair of third transverse grooves can have no points of intersection with the third transverse grooves of the circumferentially consecutive pair of third transverse grooves.

Conveniently, the third transverse grooves can have smaller extent than the second section of the second transverse grooves.

Preferably, at least two third transverse grooves extend from each second section of the second transverse grooves, more preferably from several segments of said second transverse grooves.

Advantageously, one of the aforesaid at least two third transverse grooves can extend from an end of the second section.

Conveniently, at least two of the aforesaid third transverse grooves can extend parallel to each other toward the respective edge of the tread band.

Preferably, the plurality of grooves can comprise pairs of substantially straight fourth transverse grooves.

Advantageously, the fourth transverse grooves are opposed to each other relative to the equatorial plane.

Preferably, the pairs of fourth transverse grooves can be arranged circumferentially alternated with the pairs of second transverse grooves, more preferably in a one-to-one ratio.

Advantageously, the fourth transverse grooves extend at and away from the equatorial plane so as to form an angle smaller than or equal to 75° and greater than or equal to 40°.

Preferably, the fourth transverse grooves extend away from an equatorial plane of the tyre and are substantially parallel to the first transverse grooves.

Conveniently, the fourth transverse grooves have an extent at most 15% of an effective width of the tread band.

Advantageously, the fourth transverse grooves comprise at least two disjoined segments. The aforesaid disjointed segments can be skew. Preferably, the disjoined segments of the fourth transverse grooves can be provided to be skew by a maximum distance of five times the width of the same segments.

Preferably, the fourth transverse grooves can intersect at least one first transverse groove.

Preferably, the intersections of the first transverse grooves with the fourth transverse grooves form acute angles smaller than or equal to 75°.

Conveniently, the fourth transverse grooves can have width smaller than the width of the first transverse grooves.

Conveniently, the fourth transverse grooves can have depth smaller than the depth of the first transverse grooves.

Advantageously, the first transverse sipes can extend substantially from the central circumferential groove away from the equatorial plane toward the edges of the tread band.

Preferably, the first transverse sipes can extend substantially parallel to the first transverse grooves.

Conveniently, the first transverse sipes can be intersected by second transverse grooves and/or fourth transverse grooves.

Preferably, the first transverse sipes can be arranged circumferentially alternated with the first transverse grooves, at least in a two-to-one ratio.

Preferably, the third transverse grooves can extend over the continuation of some first transverse sipes.

Further characteristics and advantages of the invention will become more apparent from the detailed description of some preferred, but not exclusive, embodiments of a winter car tyre and in particular a winter tyre for top-line cars according to the present invention.

### BRIEF DESCRIPTION OF THE DRAWINGS

This description will be set forth hereinafter by referring to the attached drawings provided for illustration purposes only and without limitation, in which:

FIG. 1 is a schematic plan view of a portion of the tread band of a first example of tyre according to the invention;

FIG. 2 is a cross sectional view of the tyre of FIG. 1.

### DETAILED DESCRIPTION OF EMBODIMENTS OF THE INVENTION

With reference to the attached figures, the pattern of the tread 1 of a winter tyre for car wheels and in particular for wheels of top-line cars according to the present invention is described.

The tyre structure itself is of a conventional type and comprises a carcass, a tread band 1 placed at the crown of the carcass, a pair of axially opposed sidewalls terminating into beads which are reinforced with bead cores and respective bead fillers. The tyre also preferably comprises a belt structure interposed between the carcass and tread band. The carcass comprises one or more carcass plies anchored to the bead cores, whereas the belt structure comprises two belt strips radially overlapping each other. The belt strips are formed by pieces of rubberized fabric encasing metal cords parallel to each other in each strip and crossing those of adjacent strips, preferably symmetrically inclined relative to the equatorial plane. Preferably, the belt structure also comprises a third belt strip, in a radially outermost position, provided with cords oriented substantially parallel to the equatorial plane. Preferably, although not necessarily, the tyre according to the invention has a nominal section width of at least about 225, more preferably at least about 245. For example, the tyre may have a nominal section width of 225, 245, 275, 295. In any case, the Applicant believes that the present invention is also applicable in the case of smaller nominal section widths (e.g. 185 or 195). Preferably, the tyre according to the invention has a reduced section height. For example, the section height can be smaller than or equal to 60%, more preferably smaller than or equal to 50% of the nominal section width.

To ensure long mileage and at the same time ensure high performance throughout the life of the tyre, particularly with regard to driveability on wet and/or snowy road surfaces, the tread 1 has an overall void-to-rubber ratio equal to or greater than 0.3, preferably greater than 0.31, even more preferably greater than 0.32.

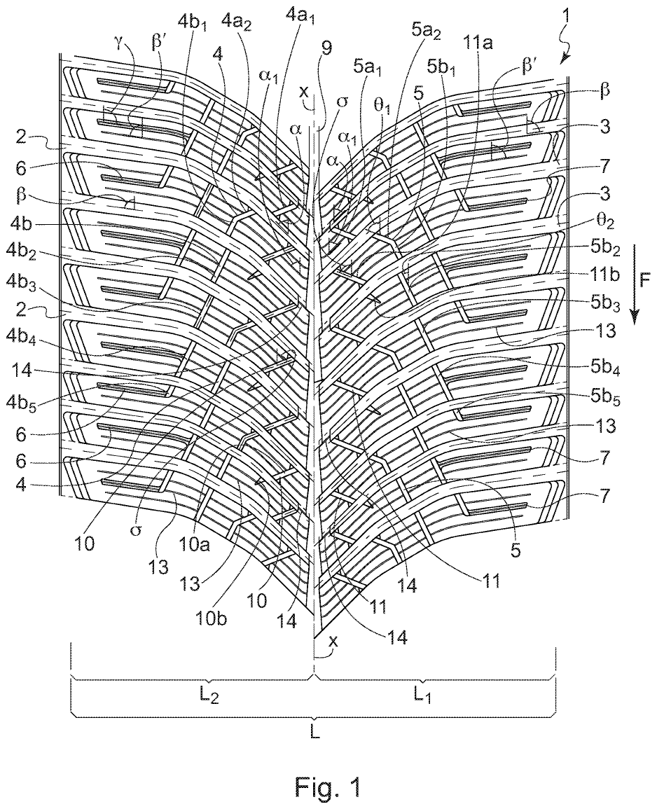

Preferably, though not necessarily, the tyre according to the invention is of the directional type, that is, the tread configuration preferably defines a preferred rolling direction for said tyre. This rolling direction is denoted by an arrow F in FIG. 1.

Moreover, the tyre according to the invention is preferably a symmetrical tyre so that the equatorial plane X-X partitions the tread band 1 into two substantially symmetrical halves, except for a slight circumferential offset between the two halves.

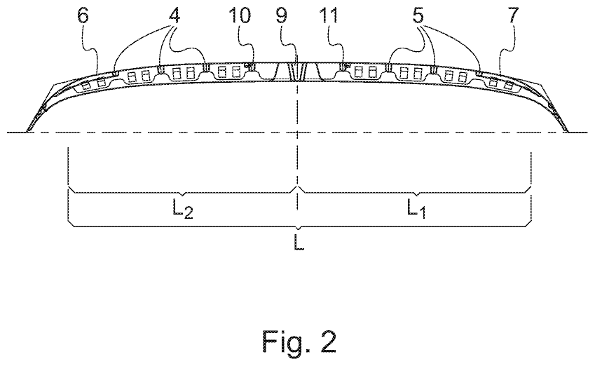

The tread 1 comprises a substantially circumferential central groove 9 arranged at the equatorial plane X-X so as to separate the tread band into two, first and second, regions L1 and L2 arranged to the right and left of the equatorial plane X-X, respectively, and substantially symmetrical. The first L1 and second L2 regions extend from the respective axial ends of the tread band to the equatorial plane X-X. Although they are not represented by clearly recognizable edges, the tread ends can be defined by the intersection of extensions, in the substantially axial direction, of the radially outermost portion of the tread and the extensions, in the substantially radial direction, of the axially outermost portions of tread 1, as shown in FIG. 2.

The central circumferential groove 9 has a maximum width smaller than 12 mm, more preferably a maximum width greater than 5 mm.

Preferably, the circumferential groove 1 may have depth greater than, or equal to, about 7 mm, more preferably greater than, or equal to, about 8 mm, however smaller than, or equal to, about 15 mm.

The central circumferential groove 9 is a wide and deep groove mainly provided for water drainage from the most central portion of the footprint area.

In the embodiment shown in FIGS. 1, 2, the central circumferential groove 9 extends circumferentially with a substantially straight shape but formed by walls arranged in broken lines, oblique relative to the circumferential direction. Specifically, the walls arranged in a region L1, L2 of tread band 1 can be circumferentially offset relative to the walls arranged in the remaining region.

Alternatively, the central circumferential groove 9 extends circumferentially with a zigzag shape, formed by inclined and counter-inclined sections.

In addition, the tread band 1 has a plurality of pairs of first transverse grooves 2, 3 arranged in sequence along the circumferential extent of the tyre.

More specifically, each pair has two first transverse grooves 2, 3 opposed relative to a direction parallel to the equatorial plane X-X, so that each first transverse groove 2, 3 of the pair extends through a region L1, L2 of the tread band 1.

In the embodiment shown in FIGS. 1, 2, the first transverse grooves 2 extend through the second region L2, whereas the first transverse grooves 3 extend through the first region L1.

The first transverse grooves 2 of the second region L2 are circumferentially offset relative to the first transverse grooves 3 of the first region L1.

Preferably, the first transverse grooves 2, 3 extend from the respective edge of the tread band 1 in the direction of the equatorial plane X-X.

The first transverse grooves 2, 3 of a pair of first transverse grooves 2, 3 have no points of intersection with the first transverse grooves 2, 3 of the circumferentially consecutive pair of first transverse grooves 2, 3.

The first transverse grooves 2, 3 have non-negligible extent, indeed their extent is equal to at least 40% of the effective width L of the tread band 1.

Preferably, in some embodiments, such as the one shown in FIG. 1, some of the first grooves 2, 3 extend from the respective edge of the tread band 1 to open into the central circumferential groove 9.

Preferably, in this embodiment, the tread band 1 has pairs of first transverse grooves 2, 3 which extend from the respective edge of the tread band 9 to open into the central circumferential groove 9 as alternated with pairs of first transverse grooves 2, 3 which extend from the respective edge of the tread band without opening into the central circumferential groove 9, but remaining spaced away therefrom. In this embodiment, a second transverse sipe 14 joins the spaced away end of the first transverse groove 2, 3 to the central circumferential groove 9.

In other embodiments, the tread band 9 has only pairs of first transverse grooves 2, 3 that extend from the respective edge of the tread band 1 without opening into the circumferential groove 1, but remaining spaced away therefrom (possibly joined to the central circumferential groove 9 by a second sipe).

Thus, the first transverse grooves 2, 3 have a first end at the respective edge of the tread band 1 and a second end arranged at or slightly away from the circumferential groove 9, preferably by an axial dimension of at most 15 mm.

Preferably, the first transverse grooves 2, 3 have an inclination which increases moving away from the equatorial plane X-X.

Preferably, at the first end, the first grooves 2, 3 have an inclination forming an angle β greater than or equal to 75° relative to a direction parallel to the equatorial plane.

At the second end, the first grooves 2, 3 have an inclination forming an angle α equal to or smaller than 60° and greater than or equal to 40° relative to a direction parallel to the equatorial plane X-X.

Preferably, the first transverse grooves 2, 3 do extend not straight but form a broken or substantially curved line.

In the embodiment shown in FIGS. 1, 2, the first transverse grooves 2, 3 extend to form a broken line consisting of three sections 2a, 2b, 2c, 3a, 3b, 3c.

Moving from the equatorial plane X-X toward the respective edge of the tread band 1, an angle of inclination of the sections 2a, 2b, 2c, 3a, 3b, 3c of each first transverse groove 2, 3 increases.

Preferably, the first transverse grooves 2, 3 are not constant in width along their extent but have a width which increases while moving axially away from the equatorial plane X-X.

Preferably, the first transverse grooves 2, 3 can have a maximum width of at least 4-5 mm. Preferably, the first transverse grooves 2, 3 can have a maximum width of about 7-8 mm.

Preferably, the first transverse grooves 2, 3 can have depth greater than, or equal to, about 5 mm, more preferably greater than, or equal to, about 6 mm, however smaller than, or equal to, about 12 mm.

By choosing to provide the first transverse grooves 2, 3 with a significant depth, good drainage characteristics can be achieved.

In addition, the tread band 1 has a plurality of pairs of second transverse grooves 4, 5 arranged in sequence along the circumferential extent of the tyre.

More specifically, each pair has two second transverse grooves 4, 5 opposed to each other relative to the equatorial plane X-X and counter-inclined relative to the first transverse grooves 2, 3.

Again in order to increase the directivity of the pattern, each second transverse groove 4, 5 of the pair extends through only one region L1, L2 of the tread band 1.

In the embodiment shown in FIGS. 1, 2, the second transverse grooves 4 extend through the second region L2, whereas the second transverse grooves 5 extend through the first region L1.

The second transverse grooves 4 of the second region L2 are circumferentially offset relative to the second transverse grooves 5 of the first region L1.

Preferably, the second transverse grooves 4, 5 also have non-negligible extent, indeed their extent is equal to at least 35% of the effective width L of the tread band 1.

The second transverse grooves 4, 5 have a first end located substantially at a second end of the first transverse grooves 2, 3 and extend away from the equatorial plane X-X, toward the respective edge of the tread band 1.

The second transverse grooves 4, 5 of a pair have no points of intersection with the second transverse grooves 4, 5 of the pair of second consecutive transverse grooves 4, 5.

Along their extent the second transverse grooves 4, 5 intersect the first transverse grooves 2, 3, in the respective region relative to the equatorial plane X-X in which they extend.

In other words, the second transverse grooves 4 located in the second region L2 of the tread band 1, relative to the equatorial plane X-X, intersect the first transverse grooves 2 located in the second region L2 of the tread band 1, just as the second transverse grooves 5 located in the first region L1 of the tread band 1 intersect the first transverse grooves 3 located in the first region L1 of the tread band 1.

The second transverse grooves 4, 5 can be formed by several, preferably straight, sections 4a, 5a, 4b, 5b.

More specifically, the second circumferential transverse grooves 4, 5 can comprise at least one substantially straight first section 4a, 5a and at least one second substantially straight second section 4b, 5b arranged consecutively to the first section 4a, 5a.

The second section 4b, 5b has extent greater than the first section 4a, 5a.

Preferably, the first sections extend through a more central portion of the tread band 1 and away from the equatorial plane X-X, and are preferably arranged to form, with the equatorial plane X-X, an angle θ₁ smaller than or equal to 75° and greater than or equal to 40°.

The first sections of the second transverse grooves 4a, 5a can be formed by two disjoined segments.

In the embodiment shown in the figures, the segments forming the first sections 4a, 5a are skew.

In the embodiment shown in the figures, the first sections 4a, 5a of the second transverse grooves 4, 5 intersect the first transverse grooves 2, 3 so that two disjointed and skew segments 4a1, 4a2, 5a1, 5a2 are defined on the first section 4a, 5a. The intersection of the first transverse grooves 2, 3 and the first sections 4a, 5a of the second transverse grooves 4, 5 forms two vertically opposed acute angles less than 75°.

Preferably, the second sections 4b, 5b of the second transverse grooves extend consecutively to the first sections 4a, 5a but through a less central portion of the tread band 1 and away from the equatorial plane X-X, and are preferably arranged to form, with the equatorial plane X-X, an angle θ₂ smaller than or equal to 50° and greater than or equal to 20°. The second sections 4b, 5b of the second transverse grooves 4, 5 can be formed by multiple segments.

Preferably, in the embodiment shown in FIGS. 1, 2, the second sections 4b, 5b of the second transverse grooves 4, 5 are formed by five disjoined segments 4b1, 5b1, 4b2, 5b2, 4b3, 5b3, 4b4, 5b4, 4b5, 5b5.

In the embodiment shown in the figures, at least some of the five segments 4b1, 5b1, 4b2, 5b2, 4b3, 5b3, 4b4, 5b4, 4b5, 5b5 forming the second sections 4b, 5b are skew.

The intersection of the first transverse grooves 2, 3 with the second sections 4b, 5b forms substantially right angles. Substantially right angles are defined as angles with an amplitude greater than or equal to about 75° and smaller than or equal to 90°.

The second transverse grooves 4, 5 have a maximum width smaller than the maximum width of the first transverse grooves 2, 3.

Preferably, the second transverse grooves 4, 5 can have a maximum width greater than or equal to about 3 mm. Preferably, they have a maximum width smaller than about 6 mm. For example, they may have a maximum width between about 3.5 and about 5.5 mm.

The second transverse grooves 4, 5 may have a substantially constant width along their extent, as in the example shown in FIGS. 1, 2.

Preferably, the second transverse grooves 4, 5 have a maximum depth smaller than the maximum depth of the first transverse grooves 2, 3.

The second transverse grooves 4, 5 can have a maximum depth of at least about 2 mm and smaller than about 7 mm.

The second transverse grooves 4, 5 may have a depth that is not constant along their respective extent, for example, a depth that decreases, preferably gradually, moving away from the equatorial plane X-X of the tread band 1.

In addition, the tread band 1 has a plurality of pairs of third transverse grooves 6, 7 arranged in sequence along the circumferential extent of the tyre and opposed to each other relative to the equatorial plane X-X.

Specifically, again in order to increase symmetry relative to the equatorial plane X-X of the tread band 1, the third transverse grooves 6, 7 are arranged in two circumferential rows of third transverse grooves 6, 7 opposed to each other relative to the equatorial plane X-X.

Preferably, the third transverse grooves 6, 7 have more limited extent than the extent of the first 2, 3 and second 4, 5 transverse grooves.

As a matter of fact, the first transverse grooves 6, 7 can have extent equal to at most 15% of the effective width L of the tread band 1.

In the embodiment shown in FIGS. 1, 2, the third transverse grooves 6, 7 extend with a straight shape.

In the embodiment shown in FIGS. 1, 2, the third transverse grooves 6, 7 extend away from the equatorial plane X-X toward the respective edge of the tread band 1, so as to form an angle γ equal to or greater than 75° relative to a direction parallel to the equatorial plane X-X.

In the embodiment shown in FIGS. 1, 2, the third grooves 6, 7 extend from the second section 4b, 5b of the second transverse grooves 4, 5 toward the respective edge of the tread band 1.

Preferably, the third transverse grooves 6, 7 have smaller extent than the second section 4b, 5b of the second transverse grooves 4, 5 from which they extend.

Preferably, at least two third transverse grooves 6, 7 extend from each second section 4b, 5b of a second transverse groove 4, 5.

In the embodiment shown in FIGS. 1, 2, two third transverse grooves 6, 7 extend from each second section 4b, 5b of a second transverse groove 4, 5.

Preferably, a first one of the two third transverse grooves 6, 7 extends from an end of the second section 4b, 5b toward the respective edge of the tread band 1, whereas the remaining one extends from the same second section 4b, 5b but in such a way as to remain circumferentially spaced away from the first one.

Preferably, the two third transverse grooves 6, 7 that extend from the same second section 4b, 5b of a second transverse groove 4, 5 are spaced away by a dimension of at most 30 mm in the circumferential direction.

The two third transverse grooves 6, 7 extending from the same second section 4b, 5b extend parallel to each other toward the respective edge of the tread band 1.

The third transverse grooves 6, 7 have a width smaller than or equal to the width of the second transverse grooves 4, 5.

Preferably, the third transverse grooves 6, 7 can have a maximum width greater than or equal to about 2.5 mm. Preferably, they have a maximum width smaller than about 6 mm. For example, they may have a maximum width between about 3 and about 5.5 mm.

The third transverse grooves 6, 7 may have a substantially constant width along their extent, as in the example shown in FIGS. 1, 2.

Preferably, the third transverse grooves 6, 7 have a maximum depth smaller than the maximum depth of the first transverse grooves 2, 3.

The third transverse grooves 6, 7 can have a maximum depth of at least about 2 mm and smaller than about 6 mm.

The third transverse grooves 6, 7 may have a depth which is not constant along their respective extent, for example their depth decreases, preferably gradually, moving away from the equatorial plane of the tread band 1.

In addition, the tread band 1 has a plurality of pairs of fourth transverse grooves 10, 11 arranged in sequence along the circumferential extent of the tyre.

More specifically, each pair of fourth transverse grooves 10, 11 has two fourth transverse grooves 10, 11 opposed to each other relative to the equatorial plane X-X, so that each fourth transverse groove 10, 11 of the pair extends through only one region L1, L2 of the tread band 1.

In the embodiment shown in FIGS. 1, 2, the fourth transverse grooves 10 extend through the second region L2, whereas the fourth transverse grooves 11 extend through the first region L1.

The fourth transverse grooves 10 of the second region L2 are circumferentially offset relative to the fourth transverse grooves 11 of the first region L1.

Preferably, the fourth transverse grooves 10, 11 do not have significant extent. In the embodiment shown in the figures, the fourth transverse grooves 10, 11 extend, preferably, only in the vicinity of the equatorial X-X plane.

Preferably, the fourth transverse grooves 10, 11 have extent of at most 10% of the effective width of the tread band 1.

Preferably, the fourth transverse grooves 10, 11 extend, in the respective region of the tread band 1, away from the equatorial plane X-X so as to form an angle σ smaller than or equal to 75°, preferably greater than or equal to 40°.

The fourth transverse grooves 10, 11 can be formed by two disjoined segments 10a, 10b; 11a, 11b.

In the embodiment shown in the figures, the first transverse grooves 2, 3 intersect the fourth transverse grooves 10, 11 so that two disjoined segments 10a, 10b; 11a, 11b are defined for each fourth transverse groove 10, 11.

The fourth transverse grooves 10, 11 can have a width smaller than or equal to the width of the first transverse grooves 2, 3.

The fourth transverse grooves 10, 11 can have a width substantially equal to the width of the second transverse grooves 4, 5.

Preferably, the fourth transverse grooves 10, 11 can have a maximum width greater than or equal to about 3 mm. Preferably, they have a maximum width smaller than about 6 mm. For example, they may have a maximum width between about 3.5 and about 5.5 mm.

Preferably, the first segments 10a, 11a of the fourth transverse grooves 10, 11 may have a substantially constant width along their extent, as in the example shown in FIGS. 1, 2.

Conversely, the second segments 10b, 11b of the fourth transverse grooves 10, 11 may have a width decreasing along their extent away from the equatorial plane X-X, as in the example shown in FIGS. 1, 2.

Preferably, the fourth transverse grooves 10, 11 have a maximum depth smaller than the maximum depth of the first transverse grooves 2, 3.

The fourth transverse grooves 10, 11 can have a maximum depth substantially equal to the maximum depth of the second transverse grooves 4, 5.

The fourth transverse grooves 10, 11 can have a maximum depth of at least about 2 mm and smaller than about 7 mm.

The fourth transverse grooves 10, 11 can have a depth that is not constant along their respective extent, for example, a depth that decreases, preferably gradually, moving away from the equatorial plane X-X of the tread band 1.

In order to improve the behavior on snow, the tread band 1 further comprises first transverse sipes 13 arranged in sequence along the circumferential extent of the tyre in both the first and second regions, respectively, of the tread band 1.

For each region of the tread band 1, the first transverse sipes 13 extend from the circumferential groove 9 toward the respective edge of the tread band 1, over the entire width of the first and second regions L1, L2.

Preferably, the first transverse sipes 13 have a shape which is substantially curvilinear or formed by a substantially broken line along their entire extent.

The first transverse sipes 13 extend substantially parallel to each other and substantially parallel to the first transverse grooves 2, 3.

Thus, the first transverse sipes 13, in a section close to the circumferential groove 9, have an inclination ai greater than or equal to 40° and smaller than or equal to 60° relative to the equatorial plane X-X.

The first transverse sipes 13, in a section close to the respective edge of the tread band 1, have an inclination B′ greater than or equal to 75° relative to the equatorial plane X-X.

The minimum distance between the first transverse sipes 13, in the circumferential direction, may be greater than or equal to 4 mm.

The first transverse sipes 13 can be arranged circumferentially alternated with the first transverse grooves 2, 3, at least in a two-to-one ratio.

Preferably, the first transverse sipes 13 are arranged circumferentially alternated with the first transverse grooves 2, 3, at least in a three-to-one ratio.

The first transverse sipes 13 are further arranged so that at least one third transverse groove extends over the continuation of a first transverse sipe 13.

In the embodiment shown in the figures, the first transverse sipes 13 further intersect the second transverse grooves 4, 5 and the fourth transverse grooves 10, 11.

Preferably, the first transverse sipes 13 have a maximum width smaller than about 1.5 mm.

Preferably, the first transverse sipes 13 have a maximum width greater than or equal to 0.4 and smaller than 1.5 mm.

Preferably, the first transverse sipes 13 do not have a constant depth along their extent but, as best shown in FIG. 2, their depth is reduced at the second 4, 5 and fourth 10, 11 transverse grooves.

Preferably, the first transverse sipes 13 have a maximum depth greater than about 2 mm. The first transverse sipes 13 have a maximum depth smaller than about 7 mm.

Preferably, the maximum depth of the first transverse sipes 13 is greater than the maximum depth of the second 4, 5 and fourth 10, 11 transverse grooves.

In some embodiments, the tread band 1 further comprises second transverse sipes 14 arranged near the circumferential groove 9.

In the embodiment shown in the figures, second transverse sipes 14 extend from an end of the first transverse groove to the circumferential groove 9.

In detail, in the embodiment shown in FIGS. 1, 2, the second transverse sipes 14 extend to the central circumferential groove 9 from the second end of the first transverse groove 2, 3, that is, the end that is spaced away from but near the equatorial plane X-X.

The second transverse sipes 14 extend from the first transverse grooves 2, 3 so as to be arranged along the extent direction of the first transverse grooves 2, 3.

The second transverse sipes 14 extend parallel to the first transverse sipes 13.

Preferably, the second transverse sipes 14 extend with a straight shape.

The second transverse sipes 14 are inclined to form an angle with the equatorial plane X-X.

In detail, the second transverse sipes 14 extend so as to form an angle equal to or smaller than 60° and greater than or equal to 40° relative to the equatorial plane X-X.

The second transverse sipes 14 may have a substantially constant width along their extent, as in the examples shown in FIGS. 1, 2.

The second transverse sipes 14 have a maximum width smaller than 1.5 mm. Preferably, the second transverse sipes 14 can have a maximum width greater than or equal to 0.4 and smaller than 1.5 mm.

The second sipes 14 may have a depth that is not constant along their respective extent.

Preferably, the second transverse sipes 14 have a maximum depth greater than about 2 mm. Preferably, the second transverse sipes 14 have a maximum depth smaller than about 7 mm.

### Example

Tyres with size 245/45 R18 model Pzero Winter (Comparison), currently marketed by the Applicant were compared with tyres of the same size and having tread pattern made according to the embodiment of the invention shown in the figures (Invention).

Both tyres were assembled with inflation pressure of 2.4 bars.

A BMW 5-series car was first equipped with four tyres made according to the invention and then with four comparison tyres.

Driving behavior tests on both dry and wet road surfaces and on snow-covered ground, aquaplaning tests on both straight and curved roads, as well as instrumental tests measuring braking distance on dry, wet and snow-covered surfaces were carried out.

The driving behavior test, on road surface, dry, wet and snow-covered surface is carried out on predefined routes, typically tracks closed to traffic. By simulating some characteristic manoeuvres (such as lane changing, overtaking, slalom between cones, entering and exiting a corner) at a constant speed as well as while accelerating and decelerating, the test driver evaluates the performance of the tyre by giving the latter a numerical appraisal during the above mentioned manoeuvres.

Indoor noise tests were further conducted.

The noise tests were performed in a soundproof chamber (semi-anechoic chamber) by using a fixed turret that rotates the tyre to be tested, specifically equipped first with a tyre according to the present invention and then with two different comparative tyres for the same market segment.

In the noise test, one tyre per set is kept in contact with a rotating drum and rotated at different speeds. Furthermore, microphones are placed inside and outside the machine to measure internal and external noise, respectively.

In addition, internal noise is measured at different speeds and on different surfaces in terms of roughness.

The results of the tests are shown in Table I where the values of the ratings, except for external noise, are expressed as percentages by setting the values for the comparison tyre equal to 100.

As for the behavior tests, the rating scale represents a subjective judgment made by the test driver who is sequentially testing the compared equipment.

In the case of the mileage test, an expressed value greater than 100 compared to the comparison tyre represents a percentage improvement in terms of lower tread wear (measured by channel depth) on a mixed route including highway stretches, state roads, secondary roads and stretches of city routes.

In the case of the braking distance measurement, a value greater than 100 compared to the comparison tyre represents a shorter braking distance on the respective surface.

TABLE I

| | Comparison | Invention |
|---|---|---|
| External noise (ECE117) | — | −2 dB |
| Internal noise | 100 | 100 |
| Snow behavior | 100 | 101 |
| Aquaplaning while cornering | 100 | 101 |
| Aquaplane in straight stretch | 100 | 101 |
| Behavior on dry surface | 100 | 105 |
| Behavior on wet surface | 100 | 101 |
| Braking on snow | 100 | 102 |
| Traction on snow | 100 | 103 |
| Braking on dry surface | 100 | 106 |
| Braking on wet surface | 100 | 100 |

Thus, the tyre of the invention showed overall improvement, and in particular a very marked improvement in terms of behavior and braking on dry surfaces, as well as external noise.

Various modifications may be made to the embodiments described in detail, all anyhow remaining within the protection scope of the invention, as defined by the following claims.

1-43. (canceled)

44. A tyre provided with a tread band having a width and comprising a plurality of grooves distributed with a void-to-rubber ratio equal to or greater than 0.30 in the tread band (1), the plurality of grooves comprising:
a central circumferential groove, located at an equatorial plane (X-X) to separate a first region (L1) and a second region (L2) of the tread band from each other;
a plurality of pairs of first transverse grooves, wherein each pair having two first transverse grooves opposed to each other relative to a direction parallel to the equatorial plane (X-X);
each of the first transverse grooves having: a first end located substantially at a respective edge of the first and second regions of the tread band, a maximum width greater than or equal to 4 mm, and an extent equal to at least 40% of an effective width (L) of the tread band;
a plurality of pairs of second transverse grooves, wherein each pair having two second transverse grooves opposed to each other relative to the equatorial plane (X-X), counter-inclined relative to the first transverse grooves, and intersecting the first transverse grooves, respectively in the first region (L1) or in the second region (L2) of the tread band; the second transverse grooves having a maximum width and a depth smaller than or equal to those of the first transverse grooves, and an extent equal to at least 35% of the effective width (L) of the tread band;
the tread band further comprising a plurality of first transverse sipes extending concordantly to the first grooves.

45. The tyre according to claim 44, wherein the first grooves have a second end located substantially at the equatorial plane (X-X).

46. The tyre according to claim 44, wherein the first grooves have an inclination which increases moving away from the equatorial plane (X-X).

47. The tyre according to claim 45, wherein at the second end, the first grooves have an inclination forming an angle (x) equal to or smaller than 60° and greater than or equal to 40° relative to a direction parallel to the equatorial plane (X-X).

48. The tyre according to claim 44, wherein at the first end, the first grooves have an inclination forming and angle (B) with a direction parallel to the equatorial plane (X-X) greater than or equal to 75°.

49. The tyre according to claim 45, wherein at least some of the first transverse grooves terminate into the central circumferential groove at the respective second end.

50. The tyre according to claim 45, wherein at least some of the first grooves have second ends spaced away from the central circumferential groove.

51. The tyre according to claim 44, wherein the first transverse grooves of a pair of first transverse grooves do not have intersection points with the first transverse grooves of the circumferentially consecutive pair of first circumferential grooves.

52. The tyre according to claim 44, wherein the second transverse grooves of a pair of second transverse grooves do not have intersection points with the second transverse grooves of the circumferentially consecutive pair of second transverse grooves.

53. The tyre according to claim 45, wherein some of the second transverse grooves extend from the second ends of the first transverse grooves.

54. The tyre according to claim 44, wherein the second transverse grooves comprise at least one substantially straight first section and at least one substantially straight second section arranged consecutively to the first section; and the second section having an extent greater than the extent of the first section.

55. The tyre according to claim 54, wherein the second section has an inclination smaller than the inclination of the first section.

56. The tyre according to claim 54, wherein the at least one first section has an inclination forming an angle (θ₁) smaller than or equal to 75° and greater than or equal to 40° relative to a direction parallel to the equatorial plane (X-X).

57. The tyre according to claim 54, wherein the at least one second section has an inclination forming an angle (θ₂) smaller than or equal to 50° and greater than or equal to 20° relative to a direction parallel to the equatorial plane (X-X).

58. The tyre according to claim 54, wherein the first segment comprises at least two disjoined segments.

59. The tyre according to claim 58, wherein the disjoined segments of the first section are skew.

60. The tyre according to claim 54, wherein the second section comprises at least three disjoined segments.

61. The tyre according to claim 60, wherein the second section comprises five disjoined segments.

62. The tyre according to claim 60, wherein the disjoined segments of the second section are skew.

63. The tyre according to claim 54, wherein the second section intersects at last two first transverse grooves.

64. The tyre according to claim 63, wherein the intersections between the first transverse grooves and the second sections form substantially right angles.

65. The tyre according to claim 54, wherein the first section intersects at least one first transverse groove.

66. The tyre according to claim 65, wherein the intersections between the first transverse grooves and the first sections form acute angles smaller than or equal to 75°.

67. The tyre according to claim 54, wherein the plurality of grooves further comprises pairs of substantially straight third transverse grooves opposed to each other relative to the equatorial plane (X-X).

68. The tyre according to claim 67, wherein some of the third grooves extend from the second section of the second transverse grooves.

69. The tyre according to claim 67, wherein some of the third grooves extend towards the respective edge of the tread band to form an angle γ equal to or greater than 75° relative to a direction parallel to the equatorial plane (X-X).

70. The tyre according to claim 67, wherein the third transverse grooves have a width smaller than or equal to the width of the first transverse grooves.

71. The tyre according to claim 67, wherein the third transverse grooves of a pair of third transverse grooves do not have intersection points with the third transverse grooves of the circumferentially consecutive pair of third transverse grooves.

72. The tyre according to claim 67, wherein the third transverse grooves have an extent smaller than the extent of the second section of the second transverse grooves.

73. The tyre according to claim 67, wherein at least two third transverse grooves extend starting from each second section of the second transverse grooves.

74. The tyre according to claim 73, wherein one of the at least two third transverse grooves extends from an end of the second section.

75. The tyre according to claim 73, wherein the at least two third transverse grooves extend parallel to each other towards the respective edge of the tread band.

76. The tyre according to claim 44, wherein the plurality of grooves comprises pairs of substantially straight fourth transverse grooves opposed to each other relative to the equatorial plane (X-X).

77. The tyre according to claim 76, wherein the fourth transverse grooves of the pairs of fourth transverse grooves extend at the equatorial plane and away from the equatorial plane (X-X) to from an angle (σ) smaller than or equal to 75° and greater than or equal to 40°.

78. The tyre according to claim 76, wherein the pairs of fourth transverse grooves are arranged circumferentially alternated with the pairs of second transverse grooves.

79. The tyre according to claim 76, wherein the fourth transverse grooves have an extent equal to at most 15% of an effective width (L) of the tread band.

80. The tyre according to claim 76, wherein the fourth transverse grooves intersect at least at least one of the first transverse grooves.

81. The tyre according to claim 76, wherein the fourth transverse grooves have a width smaller than the width of the first transverse grooves.

82. The tyre according to claim 76, wherein the fourth transverse grooves have a depth smaller than the depth of the first transverse grooves.

83. The tyre according to claim 44, wherein the first transverse sipes substantially extend from the central circumferential groove away from the equatorial plane (X-X) towards the edges of the tread band, parallel to the first transverse grooves.

84. The tyre according to claim 44, wherein the first transverse sipes are intersected by the second transverse grooves, by the fourth transverse grooves, or both.

85. The tyre according to claim 44, wherein the first transverse sipes are arranged circumferentially alternated with the first transverse grooves at least according to a 2-to-1 ratio.

86. The tyre according to claim 67, wherein the third transverse grooves extend on the continuation of some of the first transverse sipes.
